(19) United States
(12) Patent Application Publication
(10) Pub. No.: US 2008/0301956 A1
(43) Pub. Date: Dec. 11, 2008

(54) INCLINATION-DETECTING DEVICE

(76) Inventors: Wen-Jan Hong, Taoyuan (TW); Hiroshi Shimizu, Yokohama-Shi (JP)

Correspondence Address: CHRISTIE, PARKER & HALE, LLP, PO BOX 7068, PASADENA, CA, 91109-7068, US

(21) Appl. No.: 12/062,422

(22) Filed: Apr. 3, 2008

(30) Foreign Application Priority Data
Jun. 7, 2007 (TW) 096209330

(51) Int. Cl. G01C 9/02

(52) U.S. Cl. 33/355 R

(57) ABSTRACT

An inclination-detecting device includes a casing, a magnet, and a magnetic field detecting unit. The casing is formed with a cavity therein. The cavity is defined by a cavity-defining wall that has equal numbers of sides and corners. The magnet is disposed movably in the cavity in the casing. The magnetic field-detecting unit is mounted on the casing.

### CROSS-REFERENCE TO RELATED APPLICATION

This application claims priority of Taiwanese application no. 096209330, filed on Jun. 7, 2007.

### BACKGROUND OF THE INVENTION

1. Field of the Invention

This invention relates to an inclination-detecting device, more particularly to an inclination-detecting device that is capable of detecting an inclination thereof in different directions.

2. Description of the Related Art

FIGS. 1 and 2 illustrate a conventional inclination-detecting device that includes a casing 201, a permanent magnet 202, and first and second sensors 26, 27. The casing 201 includes lower and upper casing parts 205, 200. The lower casing part 205 is formed with an L-shaped cavity 204 therein that has first and second sections, each of which has an end 206, 207. The upper casing part 200 is fastened releasably on a top side of the lower casing part 205 and covers the cavity 204. The permanent magnet 202 is disposed movably in the cavity 204. Each of the first and second sensors 26, 27 is mounted on a bottom side of the lower casing part 205 and is disposed at the end of a respective one of the first and second sections 206, 207 of the cavity 204.

In operation, when the conventional inclination-detecting device is disposed at a first inclined position, where the end 206 of first section of the cavity 204 is disposed lower than the end 207 of the second section of the cavity 204 and where the permanent magnet 202 is disposed at the end 206 of the first section of the cavity 204, only the first sensor 26 detects the magnetic field of the permanent magnet 202. On the other hand, when the conventional inclination-detecting device is disposed at a second inclined position, where the end 207 of the second section of the cavity 204 is disposed lower than the end 206 of the first section of the cavity 204 and where the permanent magnet 202 is disposed at the end 207 of the second section of the cavity 204, only the second sensor 27 detects the magnetic field of the permanent magnet 202.

Although the conventional inclination-detecting device achieves its intended purpose, the conventional inclination-detecting device can only detect inclination thereof in two different directions.

### SUMMARY OF THE INVENTION

Therefore, the object of the present invention is to provide an inclination-detecting device that is capable of detecting an inclination thereof in at least three different directions.

According to the present invention, an inclination-detecting device comprises a casing, a magnet, and a magnetic field-detecting unit. The casing is formed with a cavity therein. The cavity is defined by a cavity-defining wall that has equal numbers of sides and corners. The magnet is disposed movably in the cavity in the casing. The magnetic field-detecting unit is mounted on the casing.

### BRIEF DESCRIPTION OF THE DRAWINGS

Other features and advantages of the present invention will become apparent in the following detailed description of the preferred embodiments with reference to the accompanying drawings, of which:

FIG. 1 is a perspective view of a conventional inclination-detecting device;

FIG. 2 is a sectional view of the conventional inclination-detecting device;

FIG. 3 is an exploded perspective view of the first preferred embodiment of an inclination-detecting device according to this invention;

FIG. 4 is a sectional view illustrating the first preferred embodiment in an assembled state;

FIG. 5 is a schematic top view illustrating a cavity of the first preferred embodiment;

FIG. 6 is a schematic view illustrating a magnet of the first preferred embodiment;

FIG. 7 is a schematic top view illustrating operation of the first preferred embodiment; and

FIG. 8 is a schematic top view illustrating a cavity of the second preferred embodiment of an inclination-detecting device according to this invention.

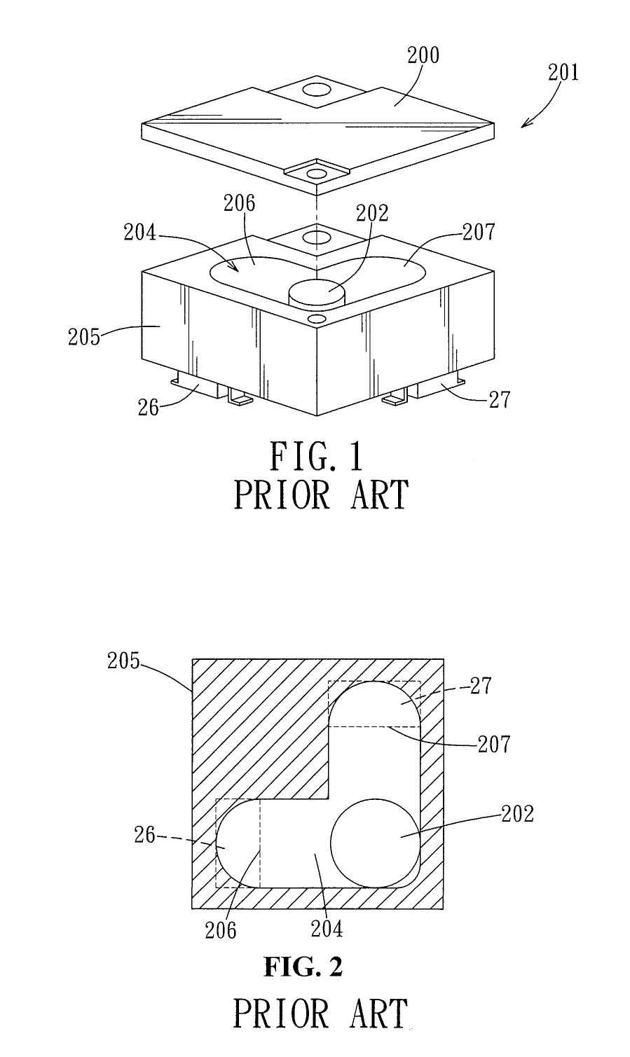

### DETAILED DESCRIPTION OF THE PREFERRED EMBODIMENTS

Before the present invention is described in greater detail, it should be noted that like elements are denoted by the same reference numerals throughout the disclosure.

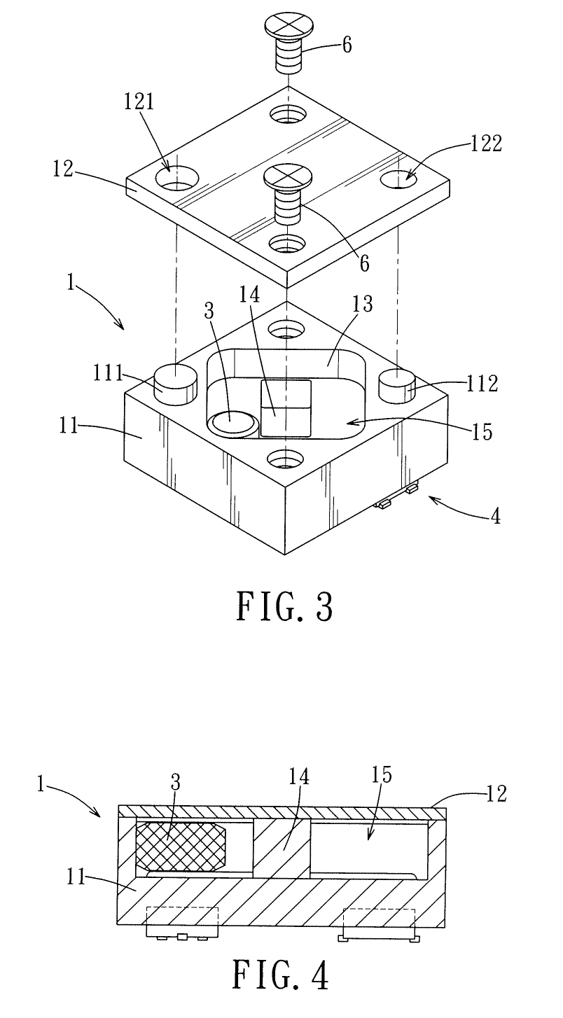

Referring to FIG. 3, the first preferred embodiment of an inclination-detecting device according to this invention is shown to include a casing 1, a magnet 3, and a magnetic field-detecting unit 4.

The inclination-detecting device of this embodiment detects an inclination thereof in four different directions, in a manner that will be described hereinafter.

The casing 1 includes lower and upper casing parts 11, 12. The lower casing part 11 is formed with a cavity 15 therein. The upper casing part 12 is fastened releasably on a top side of the lower casing part 11 and covers the cavity 15, as best shown in FIG. 4. In this embodiment, the casing 1 is made from a non-magnetically conductive material.

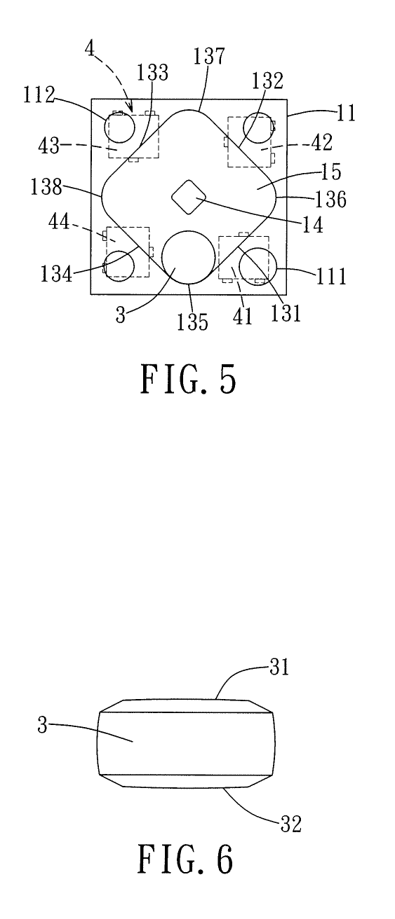

With further reference to FIG. 5, the cavity 15 in the lower casing part 11 is defined by a cavity-defining wall 13 that has equal numbers of sides and corners. In this embodiment, the cavity 15 in the lower casing part 11 has a square shape, and the cavity-defining wall 13 has four sides 131, 132, 133, 134 and four corners 135, 136, 137, 138.

In an alternative embodiment, the cavity 15 in the lower casing part 11 has a rectangular shape, a pentagonal shape, or a hexagonal shape.

The inclination-detecting device further includes a divider 14 that is disposed at a center of the cavity 15 and that extends from a bottom side of the lower casing part 11.

The magnet 3 is disposed movably in the cavity 15 in the lower casing part 11 of the casing 1. In this embodiment, as best shown in FIG. 6, the magnet 3 has a cylindrical shape, and a diameter that is larger than a height of the cavity-defining wall 13. The construction as such prevents the magnet 3 from rolling in the cavity 15 when moving in the cavity 15. Moreover, in this embodiment, the magnet 3 has opposite tapered ends 31, 32, each of which is in sliding contact with a respective one of the lower and upper casing parts 11, 12 of the casing 1, there by minimizing a frictional force between the magnet 3 and the casing 1 during movement of the magnet 3 in the cavity 15. Further, in this embodiment, the magnet is a permanent magnet.

The upper casing part 12 is formed with a pair of holes 121, 122 therethrough, each of which is disposed at a respective one of opposite corners of thereof. The inclination-detecting device further includes a pair of protrusions 111, 112, each of which is formed on a respective one of opposite corners of the top side of the lower casing part 11 and each of which extends into a respective one of the holes 121, 122. In this embodiment, the protrusions 111, 112 have different sizes to thereby indicate the orientation of the inclination-detecting device of this invention.

The magnetic field-detecting unit 4 is disposed externally of the casing 1, is mounted on the bottom side of the lower casing part 11 of the casing 1, and includes four sensors 41, 42, 43, 44, each of which is disposed at a respective one of the sides 131, 132, 133, 134 of the cavity-defining wall 13. In this embodiment, each of the sensors 41, 42, 43, 44 is a magneto-resistive sensor.

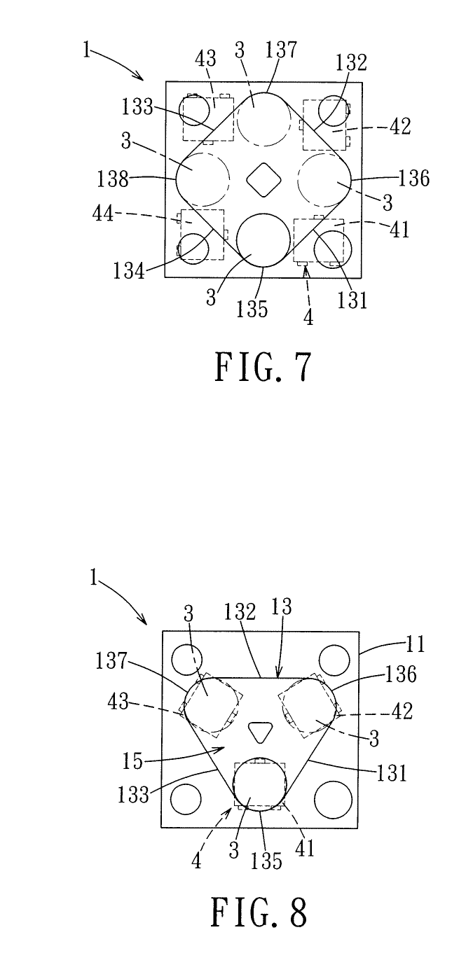

In operation, referring to FIG. 7, when the inclination-detecting device of this embodiment is disposed at an inclined position such that the corner 135 of the cavity-defining wall 13 is disposed lower than the corners 136, 137, 138 of the cavity-defining wall 13 and such that the magnet 3 is disposed at the corner 135 of the cavity-defining wall 13, only the sensor 41 detects the magnetic field of the magnet 3. Moreover, when the inclination-detecting device of this embodiment is disposed at an inclined position such that the corner 136 of the cavity-defining wall 13 is disposed lower than the corners 135, 137, 138 of the cavity-defining wall 13 and such that the magnet 3 is disposed at the corner 136 of the cavity-defining wall 13, only the sensor 42 detects the magnetic field of the magnet 3. Further, when the inclination-detecting device of this embodiment is disposed at an inclined position such that the corner 137 of the cavity-defining wall 13 is disposed lower than the corners 135, 136, 138 of the cavity-defining wall 13 and such that the magnet 3 is disposed at the corner 137 of the cavity-defining wall 13, only the sensor 43 detects the magnetic field of the magnet 3. In addition, when the inclination-detecting device of this embodiment is disposed at an inclined position such that the corner 138 of the cavity-defining wall 13 is disposed lower than the corners 135, 136, 137 of the cavity-defining wall 13 and such that the magnet 3 is disposed at the corner 138 of the cavity-defining wall 13, only the sensor 44 detects the magnetic field of the magnet 3.

A circuit (not shown) is coupled to the magnetic field-detecting unit 4. The circuit is operable so as to identify which one of the sensors 41, 42, 43, 44 of the magnetic field-detecting unit 4 has detected the magnetic field of the magnet 3 and so as to determine an inclination direction of the inclination-detecting device of this embodiment based on the sensor 41, 42, 43, 44 identified thereby.

FIG. 8 illustrates the second preferred embodiment of an inclination-detecting device according to this invention. When compared to the previous embodiment, the inclination-detecting device of this embodiment detects an inclination thereof in three different directions, in a manner that will be described hereinafter.

In this embodiment, the cavity 15 in the lower casing part 11 of the casing 1 has a triangular shape, and the cavity-defining wall 13 has three sides 131, 132, 133 and three corners 135, 136, 137. Moreover, in this embodiment, the magnetic field-detecting unit 4 is dispensed with the sensor 44 (see FIG. 5), and each of the sensors 41, 42, 43 thereof is disposed at a respective one of the corners 135, 136, 137 of the cavity-defining wall 13. Further, in this embodiment, each of the sensors 41, 42, 43 is a Hall integrated circuit.

In operation, when the inclination-detecting device of this embodiment is disposed at an inclined position such that the corner 135 of the cavity-defining wall 13 is disposed lower than the corners 136, 137 of the cavity-defining wall 13 and such that the magnet 3 is disposed at the corner 135 of the cavity-defining wall 13, only the sensor 41 detects the magnetic field of the magnet 3. Moreover, when the inclination-detecting device of this embodiment is disposed at an inclined position such that the corner 136 of the cavity-defining wall 13 is disposed lower than the corners 135, 137 of the cavity-defining wall 13 and such that the magnet 3 is disposed at the corner 136 of the cavity-defining wall 13, only the sensor 42 detects the magnetic field of the magnet 3. Further, when the inclination-detecting device of this embodiment is disposed at an inclined position such that the corner 137 of the cavity-defining wall 13 is disposed lower than the corners 135, 136 of the cavity-defining wall 13 and such that the magnet 3 is disposed at the corner 137 of the cavity-defining wall 13, only the sensor 43 detects the magnetic field of the magnet 3.

In addition, as in the case of the previous embodiment, a circuit (not shown) is coupled to the magnetic field-detecting unit 4. The circuit is operable so as to identify which one of the sensors 41, 42, 43 of the magnetic field-detecting unit 4 has detected the magnetic field of the magnet 3 and so as to determine an inclination direction of the inclination-detecting device of this embodiment based on the sensor 41, 42, 43 identified thereby.

While the present invention has been described in connection with what are considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. An inclination-detecting device, comprising:
a casing formed with a cavity therein, said cavity being defined by a cavity-defining wall that has equal numbers of sides and corners;
a magnet disposed movably in said cavity in said casing; and
a magnetic field-detecting unit mounted on said casing.

2. The inclination-detecting device as claimed in claim 1, wherein said magnet has opposite tapered ends, each of which is in sliding contact with said casing.

3. The inclination-detecting device as claimed in claim 1, wherein said magnet has a cylindrical shape, and a diameter larger than a height of said cavity-defining wall.

4. The inclination-detecting device as claimed in claim 1, wherein said magnetic field-detecting unit includes a plurality of sensors, the number of which is equal to the number of sides of said cavity-defining wall.

5. The inclination-detecting device as claimed in claim 4, wherein each of said sensors is disposed at a respective one of said sides of said cavity-defining wall.

6. The inclination-detecting device as claimed in claim 1, wherein each of said sensors is a magneto-resistive sensor.

7. The inclination-detecting device as claimed in claim 1, wherein said magnetic field-detecting unit includes a plurality of sensors, the number of which is equal to the number of corners of said cavity-defining wall.

8. The inclination-detecting device as claimed in claim 4, wherein each of said sensors is disposed at a respective one of said corners of said cavity-defining wall.

9. The inclination-detecting device as claimed in claim 1, wherein each of said sensors is a Hall integrated circuit.

10. The inclination-detecting device as claimed in claim 1, wherein said casing is made from a non-magnetically conductive material.

11. The inclination-detecting device as claimed in claim 1, wherein said magnet is a permanent magnet.

12. The inclination-detecting device as claimed in claim 1, wherein said casing includes
a lower casing part that is formed with said cavity, and
an upper casing part that is fastened releasably on said lower casing part and that covers said cavity.

13. The inclination-detecting device as claimed in claim 12, wherein said upper casing part is formed with a pair of holes therethrough, said inclination-detecting device further comprising a pair of protrusions that are formed on said lower casing part, each of said protrusions extending into a respective one of said holes and having a distinct size.
